(19) United States
(12) Patent Application Publication
(10) Pub. No.: US 2010/0282038 A1
(43) Pub. Date: Nov. 11, 2010

(54) Apparatus and Method

(75) Inventor: Raymond Francis Staff, Welwyn Garden City (GB)

Correspondence Address: Kane Kessler P.C., 1350 Avenue of the Americas, 26th Floor, New York, NY, 10019, US

(73) Assignee: STAFF FLOORING LIMITED, Welwyn Garden City, Hertfordshire (GB)

(21) Appl. No.: 12/741,139

(22) PCT Filed: Nov. 3, 2008
(86) PCT No.: PCT/GB2008/003719

§ 371 Date: May 3, 2010

(30) Foreign Application Priority Data
Nov. 2, 2007 (GB) 0721651.8
Nov. 3, 2008 (GB) GB2008/003719

(51) Int. Cl. B26D 1/00; B26D 7/02

(52) U.S. Cl. 83/13; 83/468.1

(57) ABSTRACT

An apparatus for cutting floor tiles (6) of readily cuttable material comprises a guiding device (10) for guiding movement of the apparatus along a vertical wall (4) adjacent to a floor (2) being covered, a cutting device for forming a downward cut (34) across a tile (6) on the floor (2), and a tie device (18) extending from the guiding device (10) and along which the cutting device (22) is adjustable towards and away from the guiding device (10).

This invention relates to an apparatus for cutting floor tiles and to a floor tiling method.

Carpet tiles are normally supplied as squares of certain standard sizes. The tiles are normally laid initially from either the centre or one corner of the area to be carpeted and laid outwardly therefrom towards the walls and doors surrounding the area. When carpet tiles have been laid to an extent where the remaining strips of floor to be carpeted are less than the standard carpet tile width, then carpet tiles must be cut to conform to the remaining strips. It is conventional to measure each remaining strip and then cut the tiles to the measured dimension, or to lay uncut carpet tiles into the remaining strips with the excess extending up the walls and then be cut off by hand.

U.S. Pat. No. 4,991,307 discloses a carpeting cutting apparatus which includes a rigid, rectangular frame of which a front member is provided with wheels arranged to be placed against a wall. A rear member of the frame consists of inner and outer L-section bars bounding a vertical slot therebetween. Immediately below the slot is mounted a carpet support tray provided at its rear corners with angle members to position a carpet tile placed on the tray. The tray is guided on lateral members of the frame for movement towards and away from the front member of the frame. The tray can be clamped in position by clamping screws at the lateral members of the frame. These members are provided with respective scales for use in correct positioning of the tray relative to the frame and thus the wall when the wheels are bearing on the wall.

In use, the frame is applied with its wheels against the wall. The tray is moved away from the wall relative to the frame until a foot fixed relative to the tray comes to abut against that edge of an outermost carpet tile nearest the wall, the tray is clamped to the frame, a carpet tile is laid upon the tray and a carpet knife is inserted down into and run along the slot between the two L-section bars, to cut the carpet tile on the tray into two pieces, the rear one of which is laid between the outermost carpet tile and the wall. This process is repeated at each outermost carpet tile along the file of carpet tiles parallel to the wall. Although this process allows accurate cutting of the carpet tile piece to be laid immediately adjacent the wall, it is almost as time-consuming as either of the conventional carpet tile cutting processes described above.

GB-A-2,326,836 discloses a portable, adjustable, cutting aid for fitting carpets which comprises front and rear elongate, profiled parts which are hinged by means of a rib on the rear part engaging in a slot on the front part. The distance between a foot on the rear part, which foot is to be placed between a carpet-retaining fixture and an adjacent boundary of the floor, and a front edge of the front part can be adjusted and then fixed by a screw and a nut which co-operate with respective arc-shaped projections from and intermediate the rear and front parts. A channel in the front part is able to accommodate the blade of a hand-held knife to cut the carpet to size. A pusher aids in holding the carpet flush with the front part to ensure accurate alignment of the carpet.

U.S. Pat. No. 4,148,142 discloses a carpet-cutting tool having a channel-form body member providing a horizontal, carpet-receiving slot. Mounted on the top leg of the body member for swinging perpendicularly to the web thereof is a handle assembly which supports a cutter assembly arranged so as to extend through an opening provided in the top leg and engage carpeting (or other sheet material) disposed between the legs. By pulling the tool relative to the material being cut, a strip of the material can be obtained for use as a baseboard (i.e. skirting board) covering, and the like.

EP-A-611,635 discloses a manually operated device for cutting strips from a floor covering, especially a carpet strip cutter, having a knife which is supported by a guide rod and having a cutting stop to which the guide rod is fastened in a longitudinally adjustable fashion and which engages beneath the floor covering by means of a lower limb. To facilitate handling, provision is made for the lower limb to be equal in length to the maximum cutting width which can be set and for the knife to be capable of being pivoted downwards until its cutting edge strikes the lower limb.

U.S. Pat. No. 5,581,894 discloses a carpet strip cutter assembly having an elongate base plate, a vertical, elongate side wall connected to the base plate, and an elongate cantilevered support arm perpendicular to the side wall. The support arm is reciprocably mounted in the side wall. A blade mounting assembly is secured to a front end of the support arm and has a blade extending downwardly therefrom. The blade is oriented above a row of grooves in the top surface of the base plate and removably received in one of the grooves. There is structure for vertically adjusting the position of the support arm so that various heights of carpet can be cut into strips of carpet having predetermined widths, for border work, carpet base, and feature strips.

According to one aspect of the present invention, there is provided an apparatus for cutting floor tiles, comprising a guiding device for guiding movement of the apparatus along a substantially vertical wall adjacent to a floor being covered, another device employable in forming a downward cut across a tile on said floor, and a tie device extending from said guiding device and connected to said other device.

Owing to that aspect of the invention, it is possible to provide a relatively simple apparatus which gives not only accurate cutting of floor tiles but allows a whole file of tiles to be cut in a single continuous movement of the apparatus, rather than one-by-one. The device which is employable in forming the cut advantageously comprises a mount and a cutter mounted, preferably adjustably, thereon, so that there is no need for the user to remember to have a cutter to hand. Alternatively, the device could have simply a slot for guiding a hand-held cutter parallelly to a wall, or even a straight, robust edge against which the user can guide a cutter parallelly to the wall.

Advantageously, the other device is adjustable along the tie device towards and away from the guiding device. The tie device may be permanently, rigid with the guiding device if the apparatus is used only for cutting files of floor tiles which are parallel to walls but, if the apparatus is to be used also to cut obliquely ranks of floor tiles which are being laid adjacent to oblique walls, the tie device is advantageously turnable about vertical axes relative to the guiding device and the other device, with the other device preferably being adjustable along the tie device. In the latter case, the guiding device and the tie device are advantageously releasably settable, in a continuously variable manner, about the vertical axis of the their relative turning. The guiding device preferably has a convexly curved leading edge for guiding the movement of the apparatus along the wall. Particularly advantageously, that convexly curved leading edge is provided by the periphery of a wheel for rolling along the wall. Two ties devices may be present, so as to provide, in combination with the guiding device and the other device, a parallelogram linkage.

According to a second aspect of the present invention, there is provided a method comprising laying a plurality of floor tiles over a floor to adjacent to a substantially vertical wall and leaving a substantially horizontal gap between an outermost tile and said wall, propelling along said wall a unitary apparatus comprising not only a cutting arrangement which thereby forms a downward cut across said outermost tile, but also a guiding device which bears on said wall and thereby causes said cut to be formed substantially parallelly to said wall, and lifting from said floor the portion of said outermost tile between said cut and said wall.

Owing to this aspect of the present invention, it is possible to cut floor tiles extending in a file parallel to the wall, by a substantially continuous motion of the apparatus parallelly to the wall, so significantly speeding up the laying method. If desired, following the lifting from the floor of that portion of the outermost tile between the cut and the wall, an uncut tile can be laid in the gap between the wall and the other portion of the outermost tile. However, for a neater finish, the other portion also is lifted from the floor, an uncut tile is laid in place of those two portions and the other portion is laid between that uncut tile and the wall.

The present invention is applicable particularly to floor tiles of readily cuttable material, such as carpet, vinyl or cork tiles.

In order that the invention may be clearly and completely disclosed, reference will now be made, by way of example, to the accompanying drawing, in which:

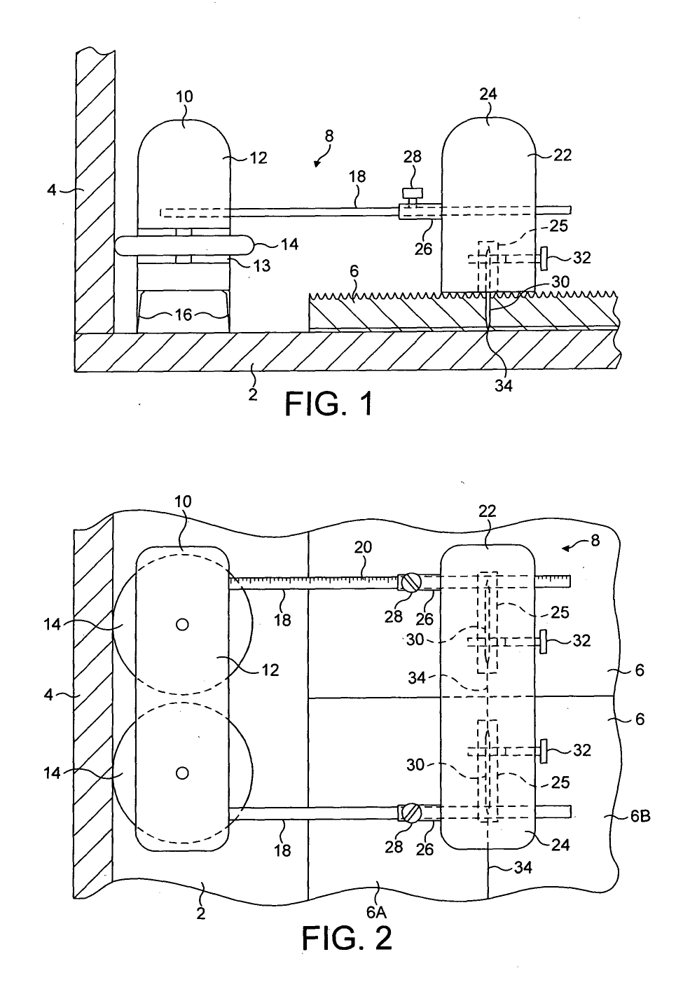

FIG. 1 shows a lateral elevation of a unitary apparatus for cutting carpet tiles, the apparatus being shown in use;

FIG. 2 is a top plan view of the apparatus of FIG. 1;

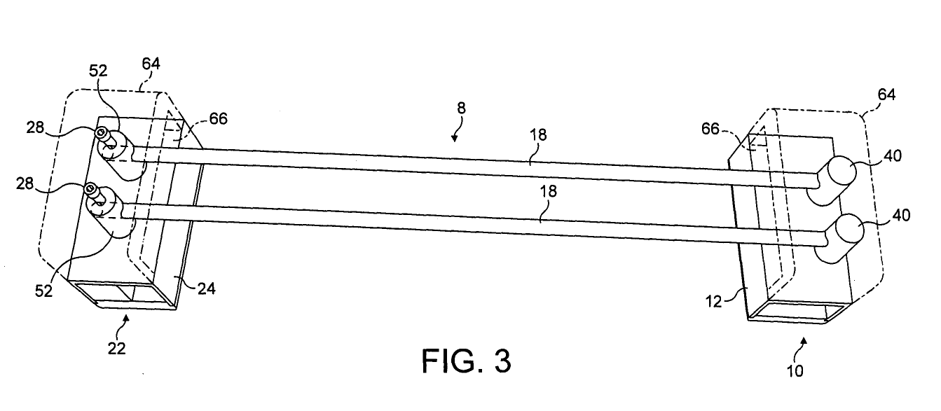

FIG. 3 is a perspective view from above of a modified version of the apparatus;

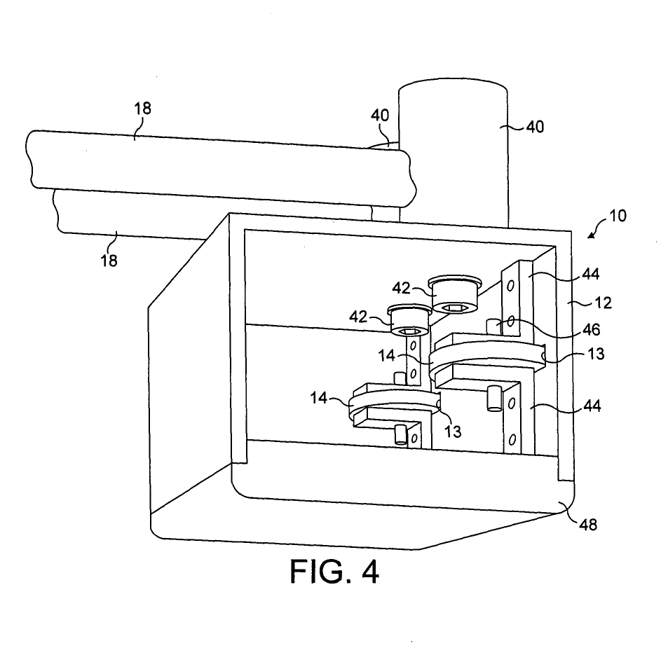

FIG. 4 is a fragmentary, underneath perspective view of the right-hand end zone of the modified version shown in FIG. 3; and

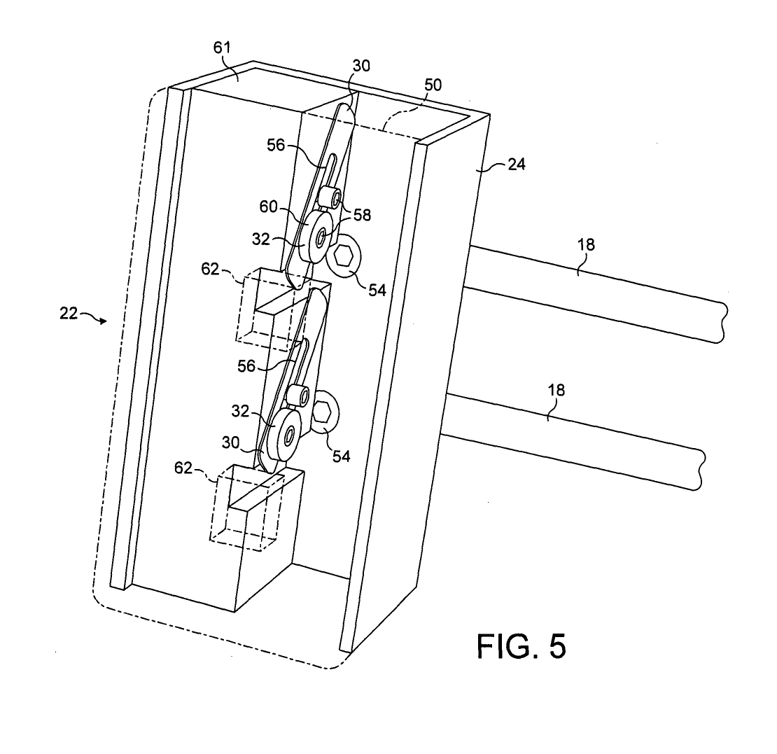

FIG. 5 is a fragmentary, underneath perspective view of the left-hand end zone of the modified version shown in FIG. 3.

Referring to FIGS. 1 and 2, there is seen fragmentarily a floor 2 and a wall 4 of a building, the wall being shown in section in FIGS. 1 and 2 and the floor being shown in section in FIG. 1. Also shown fragmentarily are square carpet tiles 6 which are in an outermost file of carpet tiles already laid on the floor parallelly to the wall 4. The tiles are held in place by tacky adhesive present either on the undersides of the tiles before they are laid, or applied over the top surface of the floor 2.

The unitary apparatus 8 comprises a guiding device 10 consisting of a mount 12 which, in horizontal slots 13 therein, mounts wheels 14 for rotating about vertical axes while rolling along the wall 4. The device 10 also includes a pair of blade-form skates 16 at the front and rear thereof and serving to slide, over the floor 2, parallelly to the wall 4. The skates 16 are of blade form in order to be relatively easy to slide over the possibly tacky surface of the floor 2. Rigidly attached to the mount 12 above the wheels 14 and extending substantially horizontally therefrom rearwardly are a pair of ties 18 one of which is provided with a scale 20. Adjustable along the ties 18 towards and away from the device 10 is a cutting device 22 comprised of a mount 24 through which the ties 18 extend. At its side facing towards the device 10, the mount 24 is formed with stub tubes 26 through which the respective tubes 18 extend and which terminate in clamping screw arrangements 28 whereby the mount 24 can be releasably fixed to the ties 18. Mounted in vertical slots 25 in the underside of the mount 24 are respective blade-form cutters 30. By means of respective releasable clamping arrangements 32, the blades 30, which are downwardly angled in their cutting conditions, can either be fully retracted into the slots 25 for safety during transportation, or project downward from the mount 24 to extents adjustable depending upon the thickness of the carpet tiles 6 to be cut. The mounts 12 and 24 are rounded at their tops so as to be comfortable when the user's hands are respectively applied thereto.

The method in which the apparatus 8 would be used is as follows. The carpet tiler lays carpet tiles 6 parallelly to the wall 4 until he is left with a strip of floor surface along the wall 4 which is too narrow for an uncut carpet tile to be laid therein. If he has not already done so, he then sets the cutters 30 to project to the extent required for the particular thickness of the carpet tiles. Moreover, if he has not already done so, he sets the position of the mount 24 along the ties 18 relative to the mount 12 so that the distance between the cutters 30 and the furthermost points on the peripheries of the wheels 14 is equal to the width of the square tiles. Then, with the wheels 14 applied to the wall 4 and the cutters 30 applied to one end of the outermost file of tiles 6, which is parallel to the wall 4, and, if desired, in a continuous movement from one end of that file to the other, he propels the apparatus 8 along the wall, with one hand applied to the mount 12 and the other hand applied to the mount 24, so forming a series of end-to-end cuts across the respective tiles of that outermost file. He then lifts the two portions (6A and 6B) of each tile in that outermost file (the portions being separated by the cut 34), against the tackiness between both portions and the floor. He then applies a file of uncut tiles in place of the cut tiles and lays the portions 6B onto the floor strip between those newly laid tiles and the wall 4.

Referring to FIGS. 3 to 5, items of the modified version corresponding generally to those of the version of FIGS. 1 and 2 are given corresponding reference numerals. The ties 18 are in the form of solid rods of which those end zones which are to be nearer the wall are fixedly mounted in respective turrets 40 which are turnable about their own axes and which can be fixed in position by tightening of respective Allen screws 42 of which the heads are within the mount 12. In FIG. 4, the Allen screws 42 are shown in untightened conditions, so that the turrets 40 are seen slightly tilted relative to the mount 12. The Allen screws 42 are accessible by an Allen key by way of the open ends of the mount 12. Each wheel 14 is supported in the mount 12 by a pair of brackets 44 which support a vertical axle 46 upon which the wheel 14 rotates. The base of the mount 12 is constituted by a rectangular block 48 of anti-friction plastics, of which the four lower edges are rounded to facilitate sliding of the device 10 over the floor. The mount 24 has a corresponding block 50 (shown in dot-dash lines for clarity). The ties 18 extend through horizontal bores through respective turrets 52 which are turnable about their own vertical axes and fixable in position on the mount 24 by respective Allen screws 54. Moreover, the position of the mount 24 along the ties 18 can be fixed by means of the clamping screws 28, which are co-axial with the turrets 52. The blade-form cutters 30 are formed with respective, longitudinal guiding slots 56 and their respective releasable clamping arrangements 32 each consist of parallel Allen screws 58 extending through the slot 56 and serving to guide longitudinal displacement of the cutter 30, and a washer 60 whereby the cutter 30 is clampable tightly against a block 62 within the mount 24. The Allen screws 54 and 58 are accessible by an Allen key by way of the half-open ends of the mount 24.

Formed through the block 50 are slots 62 through which the cutters 30 can be protruded to below the lowermost surface of the block 50 for cutting of the carpet tiles. To provide for more comfortable holding of the mounts 12 and 24 by the user, they are removably coverable by respective caps 64 (shown in dot-dash lines for the sake of clarity) which bound respective slots 66 through which extend the ties 18, allowing space for the parallelogram linkage formed by the mounts 12 and 24 and the ties 18 to be adjusted, by release and re-setting of the Allen screws 42 and 54, to cope with a situation in which a vertical wall is oblique to the axes of laying of the tiles, so that the ranks of tiles (which would be perpendicular to the files of tiles parallel to a non-oblique wall) have to be cut to match the obliquity of the oblique wall. The method of use is similar to that used for a non-oblique wall, except that the ranks of tiles are laid until no further tiles can be fitted in and then, with the angle of the mounts 12 and 24 to the ties 18 being set, by means of the Allen screws 42 and 54 to the angle of the oblique wall relative to the ranks (i.e. with the ties 18 being parallel to the ranks), and with the wheels 14 in contact with the oblique wall, the apparatus 8 is advanced parallelly to the oblique wall to cut through one or more tiles in each rank obliquely. Then, that portion of the cut tile, or those portions of the cut tiles, of each rank further from the oblique wall, as well as that portion of the cut tile, or those portions of the cut tiles, nearer the oblique wall are lifted, the cut tile (or the cut tile further from the oblique wall) is replaced by an uncut tile and those lifted portions of the cut tile(s) which was/were further from the oblique wall part is/are laid between that uncut tile and the oblique wall.

1-24. (canceled)

25. An apparatus for cutting floor tiles, comprising a guiding device for guiding movement of the apparatus along a substantially vertical wall adjacent to a floor being covered, another device employable in forming a downward cut across a tile on said floor, and a tie device extending from said guiding device and connected to said other device.

26. An apparatus according to claim 25, wherein said other device comprises a cutter and a mount for said cutter, said cutter being adjustably mounted thereon to permit adjustment of degree of actual projection of the cutter from the mount, as well as to permit full retraction of the cutter into the mount.

27. An apparatus according to claim 25, wherein said guiding device comprises one or more blade-form elements for bearing edgewise upon the floor and thereby supporting said guiding device on said floor.

28. An apparatus according to claim 27, wherein the or each blade-form element provides a skate.

29. An apparatus according to claim 25, wherein one or each of said guiding device and said other device includes an anti-friction base with rounded lowermost edges for supporting said guiding device and/or said other device.

30. An apparatus according to claim 25, wherein said tie device is turnable relative to said guiding device and said other device about respective substantially vertical axes.

31. An apparatus according to claim 30, wherein said guiding device and said tie device are releasably settable about the axis of their relative turning.

32. An apparatus according to claim 31, wherein said guiding device and said tie device are releasably settable about the axis of their relative turning as aforesaid in a continuously variable manner.

33. An apparatus according to claim 25, wherein said tie device is one of a plurality of substantially identical tie devices extending from said guiding device and connected to said other device, said other device is adjustable along said tie devices towards and away from said guiding device, and said tie devices, said guiding device and said other device constitute a parallelogram linkage whereby said tie devices are turnable relative to said guiding device and said other device about substantially vertical axes.

34. An apparatus according to claim 33, wherein said guiding device and said tie devices are releasably settable about the axes of their relative turning.

35. An apparatus according to claim 34, wherein said guiding device and said tie devices are releasably settable about the axes of their relative turning as aforesaid in a continuously variable manner.

36. A method comprising laying a plurality of floor tiles over a floor to adjacent to a substantially vertical wall and leaving a substantially horizontal gap between an outermost tile and said wall, propelling along said wall a unitary apparatus comprising not only a cutting arrangement which thereby forms a downward cut across said outermost tile, but also a guiding device which bears on said wall and thereby causes said cut to be formed substantially parallelly to said wall, and lifting from said floor the portion of said outermost tile between said cut and said wall.

37. A method according to claim 36, and further comprising lifting from said floor that portion of said outermost tile at the opposite side of said cut from the first-mentioned portion, laying another tile in place of said outermost tile, and fitting between said other tile and said wall said portion of said outermost tile which was at the opposite side of said cut from the first-mentioned portion.

38. A method according to claim 36, wherein said propelling is in a substantially continuous motion of said apparatus and causes forming not only of said cut across said outermost tile but also of a downward cut substantially parallel to said wall and across the or each of one or more additional outermost tiles near to said wall.

39. A method according to claim 36, wherein said wall is oblique to said outermost tile(s), and a parallelogram linkage comprised of said cutting arrangement, said guiding device and a plurality of tie devices articulatedly interconnecting said cutting arrangement and said guiding device has, during said propelling, said tie devices longitudinally substantially perpendicular to the outermost edge(s) of said outermost tile(s).

40. A method comprising laying a floor tile over a floor to adjacent to a substantially vertical wall, and propelling along said wall a unitary apparatus comprising not only a cutting arrangement which thereby forms a downward cut across said tile, but also a guiding device which bears on said wall and thereby causes said cut to be formed substantially parallelly to said wall, wherein said wall is oblique to said tile, and a parallelogram linkage comprised of said cutting arrangement, said guiding device and a plurality of tie devices articulatedly interconnecting said cutting arrangement and said guiding device has, during said propelling, said tie devices longitudinally substantially perpendicular to that edge of said tile nearest to said wall.
